(19) United States
(12) Patent Application Publication
(10) Pub. No.: US 2002/0171864 A1
(43) Pub. Date: Nov. 21, 2002

(54) Methods and apparatus for printing around a job in a printer queue

(76) Inventor: Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/860,192

(22) Filed: May 16, 2001

(51) Int. Cl. G06F 15/00; B41J 1/00

(52) U.S. Cl. 358/1.15; 358/1.16

(57) ABSTRACT

Methods and apparatus for printing print jobs from a print queue with a printer. The method includes providing a readable memory device defining the print queue, and storing a first print job in the print queue. A second print job is also stored in the print queue. A determination is made whether or not the first print job can be printed by the printer. If the first print job can be printed, the first print job is transmitted to the printer for printing. However, when the first print job cannot be printed, then a determination is made whether or not the second print job can be printed by the printer. When the second print job can be printed by the printer and the first print job cannot be printed by the printer, then the second print job is transmitted from the print queue to the printer for printing.

### FIELD OF THE INVENTION

The invention claimed and disclosed herein pertains to electronic imaging devices, such as electronic printers, and in particular to methods and apparatus to control print jobs in a printer queue in such devices.

### BACKGROUND OF THE INVENTION

The present invention pertains particularly to electronic imaging devices, and more particularly to an imaging device within a network. By “electronic imaging device” I mean a device, such as an electrophotographic printer or an inkjet printer, which receives a data stream of digital electronic signals representative of an image to be imaged or rendered (“printed”) by the device. In certain instances the imaging device can perform a number of different functions, such as printing, photocopying, and sending and receiving facsimiles. In response to receiving the electronic signals, the imaging device produces the image on a tangible medium (for example, on a sheet of paper). For the sake of simplicity, I will refer to any device capable of producing a tangible image resulting from a received stream of electronic signals as a “printer”. However, it is understood that this term should not be limited to devices only having printing capability.

Typically the stream of electronic signals are provided by a client device. A client device can be for example a computer terminal or a remote device attached to a telecommunications line in communication with the imaging device. For example, the imaging device can be in communication (directly or indirectly) with a modem which is in turn connected to a transmitting facsimile machine. The imaging device can also be connected to the Internet. In any event, the client device is configured to transmit the stream of electronic signals to the imaging device via a communication link. This transmission can be direct (for example, when a desk top computer is connected directly to a printer via a printer port in the computer), or indirect (for example, when a desktop computer first sends the data stream to a central controller or server that manages a plurality of client devices). The communication link between the client device and imaging device can be a physical connection, such as a wire or cable, or it can be a wireless connection, such as by a modulated radio wave (for example, infrared or the recently developed Bluetooth short range wireless communication protocol). (Bluetooth is a trademark of Telefonaktiebolaget LM Ericsson CORPORATION SWEDEN.)

The present invention is particularly useful in a network environment. By a “network” I mean a system which connects a plurality of client devices to at least one imaging device through communication links. Examples of networks are a local area network (“LAN”) and a wide area network (“WAN”). For example, a LAN can comprise a plurality of computer workstations which are connected to a central controller, which is in turn connected to one or more imaging devices. This allows users of the workstations to share a common printer, thus reducing the need to provide a dedicated printer for each workstation. The central controller performs the task of receiving the data streams from the various client devices and directing them to the imaging device. The transmission of a data stream from a client device is typically initiated by a command from a user of the client device via an applications program accessed through the client device. The command includes instructions to the controller to image (or “print”) a particular data file. The resulting data stream sent to the controller may be described as a “print job”. Imaging in a network environment will be known herein as “network printing”.

A print job comprises not just the data stream representative of the image to be printed, but also attributes to be assigned to the resultant tangible image. For example, the attributes can include whether the image is to be printed in color or monochrome (such as black-and-white), the size and type of the medium on which the image is to be printed (e.g., paper or transparencies, legal size paper or 8.5 inch by 11 inch paper), single sided or double sided printing, etc.

In a network printing system the controller (which is typically a computer) has access to a computer readable-writeable memory device, such as a hard drive or memory modules such as random access memory (or “RAM”). The memory device can be resident within the controller or external to the controller. When the controller receives a print job from a client device, the controller temporarily stores the print job in the memory device and then transmits the print job to the imaging device for printing. A number of different configurations are known. For example, the controller can delay the printing process until the entire print job is received from the client device and stored in the memory device before initiating printing, or it can initiate printing as each page of a multi-page print job is received. Further, the memory device can comprise both quick access memory (such as RAM modules), and slower access memory (such as a hard drive). The controller can then be configured to access data for immediate printing from the quick access memory, but store data not yet ready for printing on the hard drive.

The controller in a network environment is additionally configured to schedule the printing of print jobs when two or more print jobs have been submitted to the controller for printing. The controller is typically configured to instruct the printer to print jobs in the order received, that is, in a “first in—first out” basis. When a request is made by a user to print a print job, the controller prints the job if the printer is currently available. However, the printer may not always be available for printing. For example, the most common situation arises where the printer is already engaged in printing a print job, and so cannot process another print job until the first print job has been completed. In this situation the controller stores print job or jobs that cannot be printed in the memory device until the printer is available to print them. Once the printer becomes available, the controller recalls a waiting print job from the memory device and transmits it to the printer for printing. When two or more print jobs are pending, they are typically stored in the memory device in a “print queue”. Typically, the print job first received in the print queue is the first job printed. However, it is possible for a user to give a print job a higher priority if the network computer is so configured, in which case the print job having the higher priority is moved up in the queue ahead of other print jobs which are assigned a lower priority. The control of the printing of print jobs is typically controlled by a printer control program which is stored in the controller.

A problem arises when the next print job in the queue cannot be printed for one reason or another. For example, if the next print job in the queue requires a certain size or type of paper but the printer is not currently loaded with this size or type of paper, then the print job cannot be printed. In this instance the network computer holds the print job and typically notifies either the user or a network administrator (typically through a computer screen attached to the network computer) that the printer needs attention before the next print job can be printed. The situation can also arise where the system is configured to allow “secure” job printing. That is, by assigning a security code to a print job, the controller can hold the print job in the print queue until an authorized user enters a matching security code at a user interface located at the printer. Once the security code has been entered, the controller transmits the print job to the print engine for printing and the authorized user will be able to immediately obtain the document, reducing the chances for the document to be accessed by unauthorized users.

Once the user or network administrator addresses the condition which has caused the print job to be held, the print job is printed. During the period from the time that the user/administrator is notified and the printer condition is remedied, no jobs are printed. This can cause delays in printing other jobs in the queue, and can cause a large number of print jobs to accumulate in the queue, possibly exceeding the memory capabilities of the network memory device. The problem can become acute when the network administrator is unavailable to tend to the printer and other print jobs are held for a long period of time. This situation is undesirable for obvious reasons. In some environments there is no notification provided to the user/system administrator beyond a control panel message at the printer itself. Due to this lack of remote notification the problem can remain unaddressed even longer.

Prior art solutions to network printing systems do not adequately address this problem. For example, U.S. Pat. No. 5,625,757 to Kageyama et al. addresses the problem of continuing a currently printing print job once a printer error has been remedied, as well as selecting one of a plurality of printers attached to the network for printing a print job. However, Kageyama et al. do not address the problem of printable print jobs in the print queue being held up due to the inability of the printer to print another print job prior in the queue.

U.S. Pat. No. 5,845,057 to Takeda et al. solves the problem by locating another printer connected to the network to print a job which cannot be printed by the primary designated printer. However, this requires the addition of additional printers to the network, defeating one of the primary objectives for connecting client devices to a networked printer (i.e., reducing the printing facilities required to process the anticipated needs of the users). This also serves to reroute the user's print job to another printer on the network, which requires that the user be notified and locate the secondary printer. This also does not address the case where one or more of the additional printers also cannot print the job for one or more similar reasons, and user intervention is still required.

U.S. Pat. Nos. 5,881,213 and 5,960,168 to Shaw et al. address the situation when the user of a client device sends a command to an applications program resident within the client device to print a file, yet the client device is physically disconnected from the designated printer. This situation can arise, for example, when a portable computer is disconnected from the network. The solution described by Shaw et al. is to have the client device store the print job on a memory device resident within the client device, and, when the printer subsequently becomes available to the client device, to transmit the print job for printing. Similarly, Nakatsuma et al. (U.S. Pat. No. 6,115,132) describe a network printing system in which the controller stores data identifying print jobs in a queue, but does not receive the print job itself from the client devices until the printer is available to print the particular print job.

What is needed then is a way to prevent print jobs in a print queue from being unacceptably delayed by an unprintable print job prior in the queue.

### SUMMARY OF THE INVENTION

The invention includes methods and apparatus for printing print jobs from a print queue using a printer which receives print jobs from the queue. The methods and apparatus provide a way to prevent print jobs that cannot be processed (i.e., printed) without user intervention from delaying the processing of print jobs which can be printed without user intervention.

In a first embodiment the invention includes a method for printing print jobs from a print queue with a printer. The method includes the steps of providing a readable memory device defining the print queue, and storing a first print job in a first location in the print queue. A second print job is stored in a second location in the print queue. A determination is then made whether or not the first print job can be printed by the printer. When the first print job can be printed by the printer, the first print job is transmitted from the print queue to the printer for printing. However, when the first print job cannot be printed by the printer, a determination is made whether or not the second print job can be printed by the printer. When the second print job can be printed by the printer and the first print job cannot be printed by the printer, the second print job is transmitted from the print queue to the printer for printing. The method can include additional steps, such as transmitting the second print job to the printer only after a predetermined period of time has elapsed since the step of determining that the first print job cannot be printed was performed. This additional step can be accomplished by providing an activation timer to measure the elapsed time since determining that the first print job cannot be printed. When the measured time is equal to, or exceeds, the predetermined period of time, then the second print job is transmitted to the printer.

The method can further include disabling the activation timer, or enabling the activation timer if it is not enabled. The step of enabling or disabling the activation timer can be performed either at the printer itself, or at a control pont remote from the printer. . Further, the step of enabling or disabling the activation timer can itself be enabled or disabled, as for example by a system administrator. That is, a system administrator can either allow users of the system the ability to enable or disable the activation timer, or the administrator can deny users the ability to enable or disable the activation timer. Additionally, the printing of the second job “around” the first job, when the first job cannot be printed and the second job can be printed, can be activated by a user, as for example by accessing a switch on a local control panel at the printer. This allows a user to bypass the activation timer, or to cause print-around printing when the activation timer is either not provided or is disabled.

A second embodiment of the present invention comprises a computer network configured to process print jobs from a number of client devices for printing on a central printer. The network includes a central controller and a computer readable memory device which can be accessed by the central controller. The central controller can thus store electronic data to, and retrieve electronic data from, the memory device. The memory device is configured to define a print job queue. A plurality of client devices, each capable of generating a print job comprised of a data stream of electronic signals, are in signal communication with the central controller. An imaging device, such as a printer, is in signal communication with the central controller. The network also includes a printer control program which comprises a series of computer executable instructions which can be executed by the controller. The computer executable steps (or instructions) allow the controller to receive the print jobs from the client devices and store them in the print job queue. The printer control program further allows the controller to determine whether a first print job in the print job queue can be printed by the imaging device, and to transmit the first print job to the imaging device for printing when the imaging device can print the first print job. The printer control program is further configured to determine whether a second print job in the print job queue can be printed by the imaging device when the first print job in the print job queue cannot be printed by the imaging device. If the first print job cannot be printed, and the second print job can be printed, then the printer control program provides for the central controller to transmit the second print job to the imaging device for printing.

A third embodiment of the present invention provides for a computer-readable storage medium for use in a computer system having a processor configured to execute computer executable instructions to control the transmission of print job data files from a memory device to an electronic imaging device for processing by the imaging device. The medium holds computer executable instructions for performing the following functions: storing a first print job in the memory device; storing a second print job in the memory device; determining whether or not the first print job can be processed by the imaging device; and, when it is determined that the first print job cannot be processed by the imaging device, determining whether or not the second print job can be processed by the imaging device.

In one embodiment of the present invention a first user transmits a first print job to a printer for printing, and then a second user transmits a second print job to the printer for printing. A controller, which controls flow of print jobs from users to the printer, and which can be resident within the printer or external to the printer, determines that the first print job cannot be printed without user intervention, and provides a signal or alarm to this effect, the signal of alarm being sensible by the users. The first print job is thus held in a print queue (an allocated location on a memory device) along with the second print job. Preferably, the signal or alarm is provided at the printer. The printer is provided with a switch device to enable a user, such as the second user, to print the second print job prior to the first print job, even though the first print job is earlier in the print queue than the second print job. In this manner the second print job is “printed-around” the first print job. Preferably, the switch device only allows a user to print the second print job around the first print job when the first print job requires user intervention in order to be printed.

These and other aspects and embodiments of the present invention will now be described in detail with reference to the accompanying drawings, in which:

### DESCRIPTION OF THE DRAWINGS

FIG. 1 is a schematic diagram of a computer network system incorporating the methods and apparatus of the present invention;

FIG. 2 is a schematic diagram depicting the various components of a network controller which can be used to implement the present invention;

FIG. 3 is a schematic diagram depicting allocation of available memory in a memory device which can be used to implement the present invention; and

FIGS. 4A, 4B and 4C together depict a flowchart showing one example for implementing the method of the present invention.

### DETAILED DESCRIPTION OF THE INVENTION

As discussed above, a problem with prior art network printing systems is, if there is a print job in a job queue and the job cannot be printed because of a condition present at the printer, printing of all other jobs in the queue is delayed until the condition is resolved. The present invention addresses this problem by configuring a printer control program, which transmits print jobs from the job queue to the printer, to allow print jobs to be “printed-around” the print job or jobs which cannot be printed for one reason or another. For example, if a print job requires size A4 paper, which requires a special paper cassette to be loaded in the printer, then the printer can hold the A4 print job and can print other jobs which are in the queue for printing behind the A4 print job (assuming the jobs which are advanced do not require special paper or other special attention). In this manner the print jobs which can be printed are printed, while the print jobs which require special attention are held in the queue until the printer condition causing them to be held is addressed.

Preferably, the portion of the printer control program which allows this “print around” capability can be configured by a user, such as a network administrator, in various ways. For example, the printer control program can be configured to allow the user to enable or disable the print-around feature, either through a keyboard command directed to the network computer, and/or through a user interface at the printer itself. The print-around program should also preferably include a time delay feature before the program allows a print job to be printed around another job. For example, once the network computer notifies the administrator/user that the printer requires attention before the next print job can be printed, then the network computer will hold all print jobs for a predetermined period of time (for example, two minutes) to allow the system administrator or user an opportunity to address the condition. If the condition is not addressed after this delay period, then the network printer proceeds to select the next print job in the queue (i.e., the next print job which can be printed by the printer in its current configuration) and sends that print job to the printer for printing. A time delay thus preserves a certain “equity” in the print queue such that print jobs which require special attention (for example, size A4 paper) are not always automatically delayed in favor other later print jobs which use “standard paper”.

The present invention, as mentioned, pertains to processing print-jobs from a job queue in a networked environment which connects a plurality of client devices. The print jobs are processed (typically printed) using an imaging device, which I shall refer to generically as a “printer”, although this term should not be considered as limiting the invention to a printer, but is intended to encompass all devices which can generate an image from an electronic file. For example, the imaging device can include a multi-purpose device which incorporates printing, copying and facsimile receiving capabilities. Likewise, the term “client devices” is understood to include any device which is capable of sending an electronic data file or data stream to the imaging device as a “print job”, such that the file can be processed (typically printed) by the imaging device. Examples of client devices include (without by way of limitation) a computer, such as a personal computer, a facsimile machine, an Internet server, and a personal digital assistant (“PDA”).

The client devices are “connected” (or connectable) to the imaging device via communication links which form a part of the network. As described in the Background section above, the communications links can be hard-wired or wireless. The network thus comprises a plurality of client devices, an imaging device, a controller to control the flow of signals from the client devices to the imaging device, and communications links between the client devices (which can be direct or indirect links), and the controller.

One example of a network in which the present invention is particularly useful is an office environment in which a group of users are provided with individual desk top personal computers (the client devices). The personal computers are connected via a coaxial cable (the communication link) to at least one common printer (the imaging device). The users can thus transmit print jobs (data files comprising a stream of electronic signals) to the printer for processing (printing). Such a network is known as a local area network (“LAN”).

Another example of a network may be termed a wide area network (“WAN”). An example is a business having a plurality of geographically diverse locations with at least one imaging device at more than one of the locations. Each location can have users “hard-wired” to the local printers, but the printers can also be configured to receive a print job from a remote source, such as a lap-top computer having a cellular modem.

In such a networked environment the client devices may all be capable of sending print jobs to the printer for printing. To control the flow of jobs to the printer, the print jobs are typically received and stored (“spooled”) into a print queue. The process of spooling print jobs is well known in the art, and will not be specifically describe herein.

I will now describe my invention with specific reference to the attached drawings.

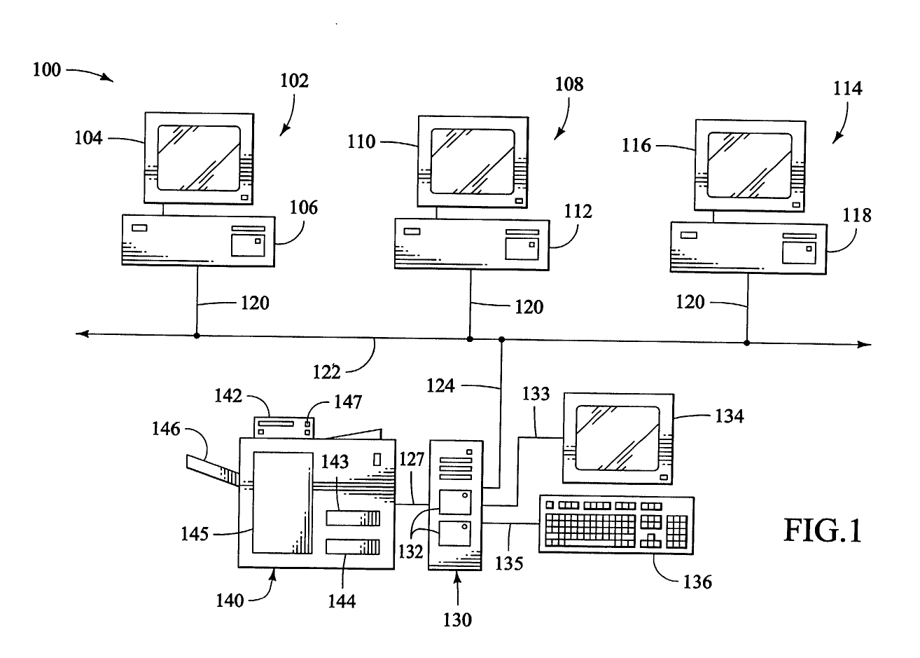

Turning to FIG. 1, a schematic diagram of an exemplary network system is depicted. The network 100 depicted in FIG. 1 can implement the methods of the present invention. It should be understood that the network 100 depicted in FIG. 1 is exemplary only, and that other configurations of networks, as described above, can also employ the methods of the present invention. The network 100 of FIG. 1 includes a plurality of client devices 102, 108 and 114, which are depicted as respective computer workstations 106, 112 and 118 having respective video monitors 104, 110 and 116. The client devices are in signal communication with a central communication link 122 via individual communication links 120. The central communication link 122 is further in communication with a central controller 130 via communication link 124. Although the communication links 120, 122 and 124 are depicted as solid links (such as a coaxial cable), it is understood that the communication links can also be wireless communication links, or a combination of hard-wired and wireless links.

The network system 100 depicted includes the central controller 130, which has memory devices 132, and is connected to a user input device (here, a keyboard) 136 and a user display station (here, a video monitor 134) via respective connections 135 and 133. The configuration of the central controller depicted allows a person, such as a systems administrator, to monitor activity on the network 100 via the monitor 134, and to intervene in the operation of the network via the keyboard 136. In other configurations the network can be configured such that provisions are not made to accommodate a systems administrator, and individual users of client devices 102, 108 and 114 can monitor network activity via monitors 104, 110 and 116. Further, users of the client devices can be provided with access to intervene in the operation of the network via individual user input devices (such as keyboards, not shown) which are connected to the workstations 106, 112 and 118.

While the central controller 130 is shown as being separate from the imaging device (printer) 140, it is understood that all of the functional elements of the central controller (which are described below) can be contained within the printer 140.

The network depicted further includes the printer 140, which, as depicted, includes a local user interface 142, a printer controller 145, and media trays 143 and 144 for containing media (such as paper) upon which images can be printed. The resultant printed images are provided to users through the media output tray 146. Other imaging devices can include additional elements, and can also delete elements shown for printer 140. For example, the printer controller 145 can be resident within an external device, such as the central controller 130.

Generally, the network performs as follows to allow users on the network to print their print-jobs using the printer 140. The user of a client device (e.g., 102) uses an applications software program accessed through, or resident within, the client device to transmit a print job, comprised of a data stream of electronic signals, via the links 120, 122 and 124, to the central controller 130. The central controller stores the print job on a memory device (132, for example), and then confirms (via link 127) that the printer 140 is currently capable of printing the print job. If so, the central controller transmits the print job to the printer for printing. If the printer is not currently capable of printing the print job (e.g., it is busy printing another job, or it does not have the right sized paper or other facilities to print the current print job), then the central controller puts the print job in the print queue (defined on a memory device in the central controller, such as 132) in the order in which the print job was received by the central controller. The print job is then subsequently transmitted by the central controller from the print queue to the printer for printing when the printer is capable of printing the print job.

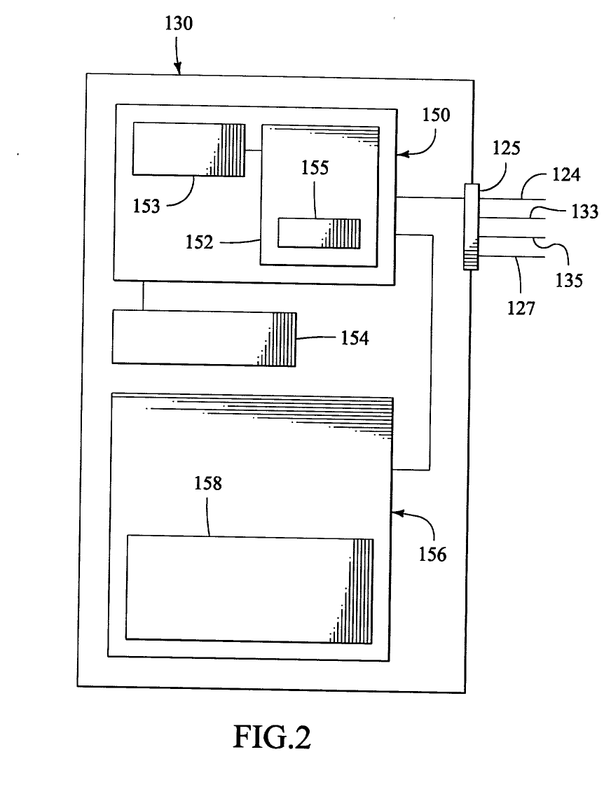

Turning now to FIG. 2, a schematic diagram of the central controller 130 depicted in FIG. 1 is depicted, showing the various components which can be contained therein. In the example shown, the controller 130 includes a processor 150 which is configured to execute a set of computer readable instructions (i.e., a “program”) to carry out designated functions. The processor 150 can be, for example, a microprocessor. The processor 150 can include a print control program 152 which allows the processor to control the printing of print jobs via the printer (140, FIG. 1). The print control program can include the print-around algorithm of the present invention. Although the printer control program 152 is depicted as being a component of the processor, the program 152 can alternately be stored in a memory device and accessed by the processor. The processor can also include an electronic clock/timer 153, the function of which will be described further below. The processor (as depicted) is in signal communication with the client devices 102, 108, 114, the administration console 136, the administration display 134, and the printer 140 via a port 125, which is connected to communication links 124, 133, 135 and 127. In a wireless communications configuration the port 125 can be replaced with a transmitter/receiver configured to transmit and receive wireless signals to and from the indicated devices.

The central controller 130 depicted in FIG. 2 further includes a computer readable memory device configured to store electronic data. The memory device can comprise a non-volatile memory component 156 (such as a hard drive), and a volatile memory component 154 (such as random access memory on memory modules). As depicted, the hard drive component 156 of the memory device defines the print queue 158. It is understood that other types of memory devices and other configurations of computer readable memory can be employed to equal effect.

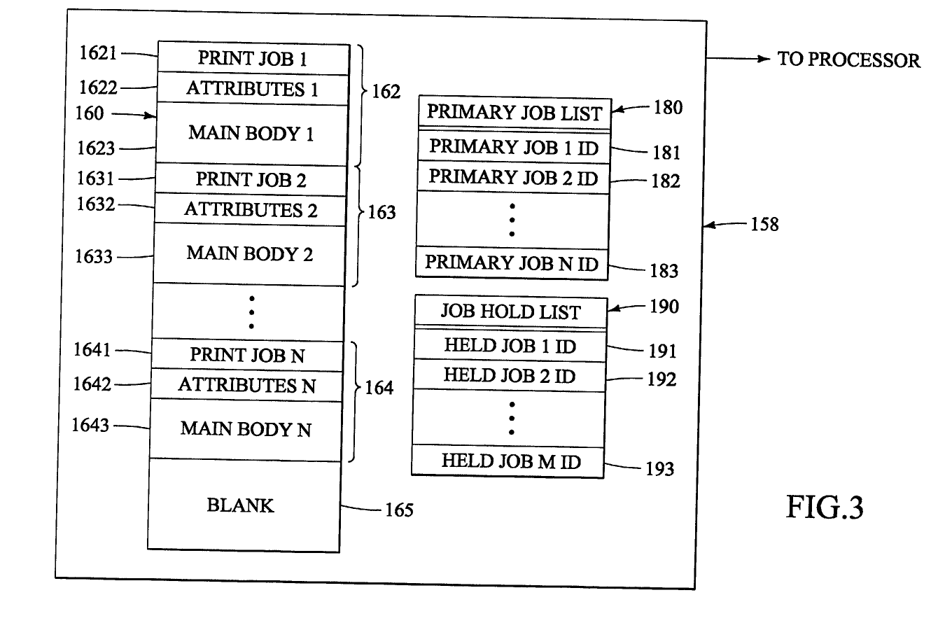

Turning now to FIG. 3, a schematic diagram of the print queue 158, which is defined in the memory device 156, is depicted. The diagram shows one manner in which a print queue can be configured to practice the methods of the present invention. The print queue essentially consists of electronic data files which are stored on the memory device in identifiable memory address locations. It is understood that memory address locations in a memory device typically are not static, and that as print jobs are added to and removed from the queue, the assigned memory address locations can change. For example, if “Print Job 1 ” 162 is printed and then deleted from the memory device, and “Print Job 2” 163 is the next print job to be printed, then Print Job 2 does not necessary move to a new memory address locations (i.e., the address locations previously occupied by Print Job 1). Further, although “Print Job N” 164 is depicted as being the next print job behind Print Job 2, there is no requirement that the next print job in the queue (e.g., “Print Job N+1 (not shown)) be placed in the memory address locations previously occupied by the now printed and deleted Print Job 1. The management of memory allocations is well known in the art, and thus will not be described in further detail. It is thus understood that the schematic diagram depicted in FIG. 3 does not represent an actual memory allocation map, but merely illustrates the organizational concepts of a print queue in accordance with the present invention.

As depicted, the print queue 158 of FIG. 3 comprises three components: a main queue of the complete print jobs 160; a primary print list or primary job list 180; and a job hold list 190. The main queue 160 is depicted as having print jobs 162, 163 and 164 positioned in the queue. Print Job 1 is stored in a first location in the queue, Print Job 2 is stored in a second location, and so on. Each print job 162, 163 and 164 is defined by an identifier (in this case, “Print Job 1” 1621, “Print Job 2” 1631, and “Print Job N” 1641). Print Job N can be a third or subsequent print job placed in the queue160. Each print job further includes a field defining print job attributes (here,“Attributes 1” 1622, “Attributes 2” 1632, and “Attributes N” 1643). The job attributes field can include such parameters as the type of paper or medium on which the print job is to be printed (e.g., transparencies, 8.5 inch by 11 inch paper, size A4 paper, etc.), as well as other attributes (e.g., color versus black and white, secure versus non-secure). Finally, each print job contains the main body of the image (Main body 1 1623, Main body 2 1633, and Main body N 1643) which is to be printed, which can be, for example, text, an image, or a photograph, or a combination or any of them.

In operation, the processor 150 of FIG. 2 can send the job attributes of a print job to the printer (140 of FIG. 1) prior to transmitting the print job to the printer for printing. The printer controller 145 can be configured to receive the job attributes from the central controller and to determine whether the printer is currently in a state to process the print job having the given print job attributes. For example, if the print job requires A4 paper, but such paper cannot currently be accessed by the printer to complete the print job, then the printer controller determines that the print job associated with the attributes cannot be printed. The printer controller can then generate an error signal indicating that the print job cannot currently be printed. This error signal can then be used by the processor 150 to alert a user (such as a system administrator via display 134, or a workstation user via display (e.g., display 104)) with an alarm (such as an audible tone or a visible message) that the associated print job cannot be printed. Preferably, the alarm or message further includes information to identify to the user the condition which has caused the print job to be held for printing, and the necessary remedy. For example, in the above example regarding size A4 paper, a visible message displayed on display 134 can be, “A4 paper required; load A4 paper”. The message can also include an additional component which can be accessed by the user via the keyboard 136, which can read, for example, “Unable to print Job 123 for user Smith received at 14:36; load A4 paper.” In addition to, or alternate to, notifying the user via one of the displays the printer 140 can generate the alarm at the printer user console 142.

Returning to FIG. 3, the print queue 158 can further include the Primary Job List 180, and the Hold Job List 190. The Primary Job List can include a list of the job identifiers (e.g., “Primary Job 1 ID” 181, “Primary Job 2 ID” 182, and “Primary Job N ID” 183) which are the same as job identifiers in the primary queue 160, except that there is not necessarily a corresponding relationship between the job names. The Primary Job List is a memory location where print job identifications are first received during processing (as will be described below), as well as a location where the identities of currently printable jobs are stored. The Job Hold List is a set of memory address locations containing the identities of print jobs which currently cannot be printed (such as “Held Job 1 ID” 191, “Held Job 2 ID” 192, and “Held Job M ID” 193). The operation of the Held Job List will be described further below.

Both the Primary Job List 180 and the Hold Job List 190 are preferably processed in a first-in-first-out manner, such that, for example, “Primary Job N ID” 183 is the most recent job identification entered on the Primary Job List, and “Primary Job 1 ID” 181 is the identification of the next job which will be processed on the Primary Job List. After Primary Job 1 has been processed and removed from the Primary Job List, “Primary Job 2 ID” 182 is the identification of the next job that will be processed.

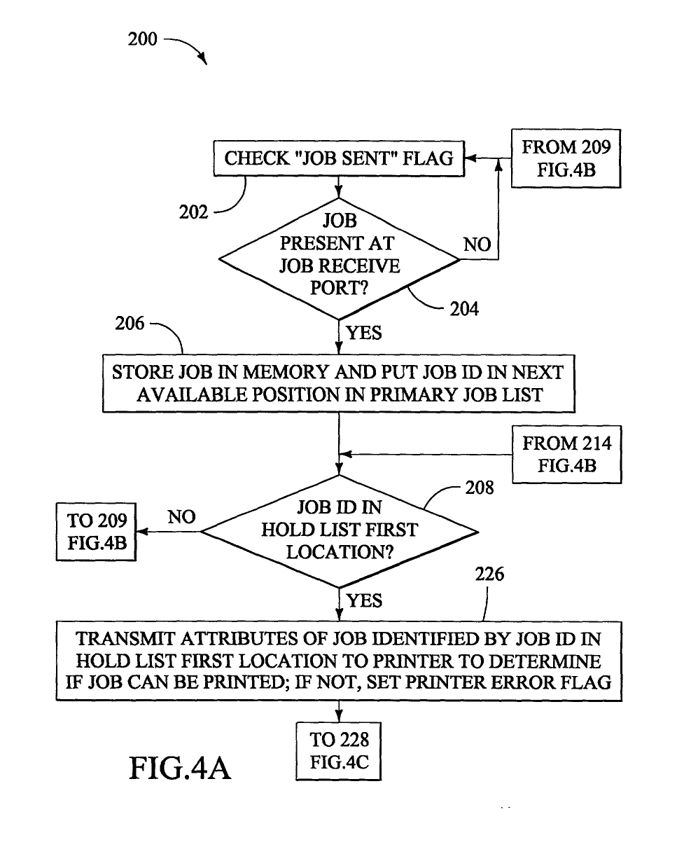

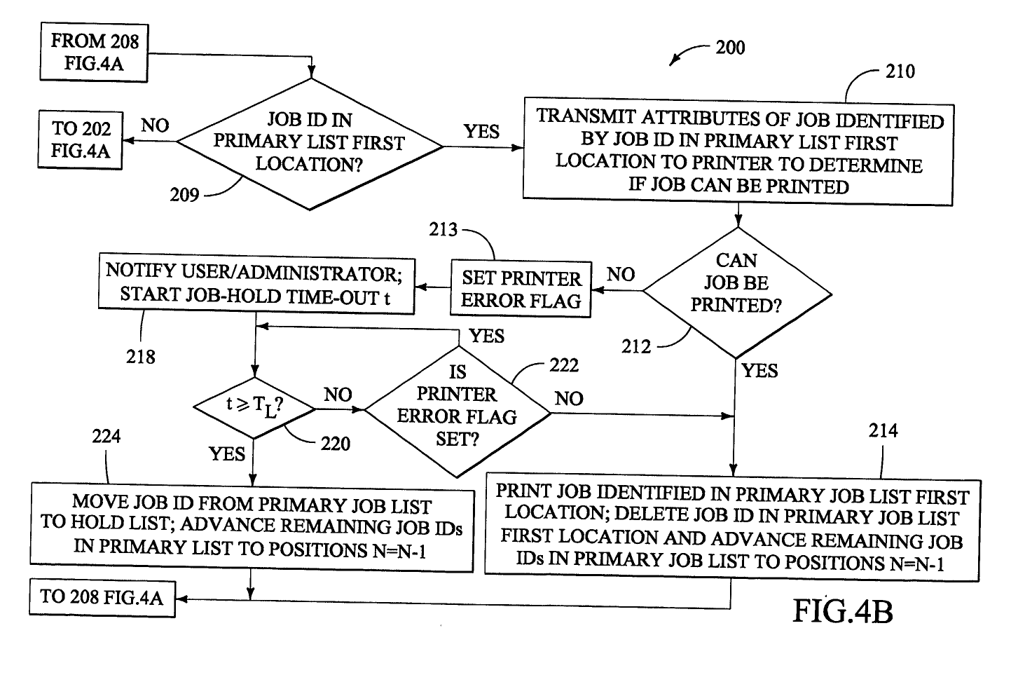

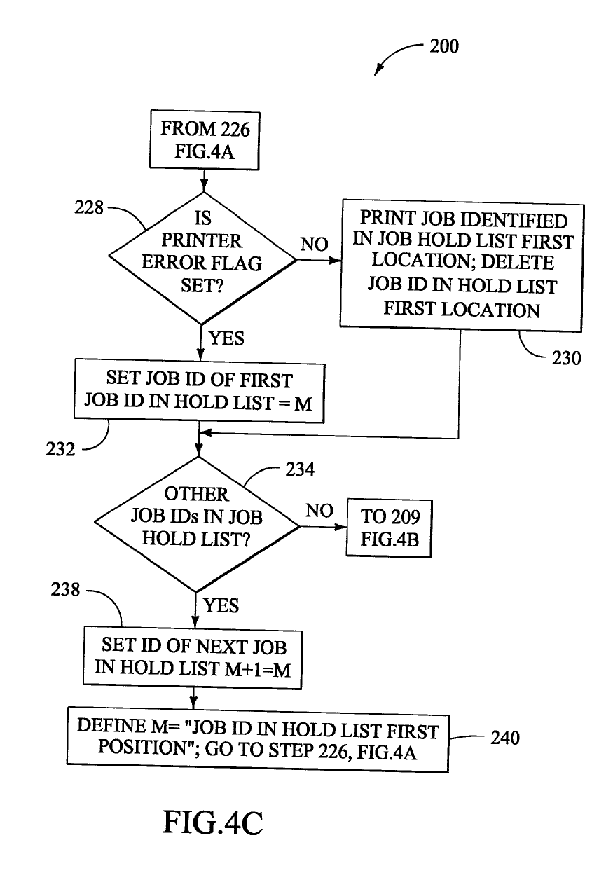

Turning now to FIGS. 4A, 4B and 4C, a flowchart 200 is depicted which presents one manner in which the method of the present invention can be implemented. The flowchart 200 essentially depicts one embodiment of a print-around program to implement a print-around algorithm, such as algorithm 155 in the printer control program 152 of FIG. 2. The flowchart essentially depicts a set of computer readable instructions which can be executed by a computer or processor to implement the described method. It is understood that the flowchart 200 depicts but one manner in which the present invention can be implemented, and that other implementations can be used to equal effect. The primary feature of the print-around program which is common to any implementation of the present invention is that the program, which embodies the algorithm, determines whether a first print job in the print queue (160 of FIG. 3) can be printed by the printer (140 of FIG. 1). If the first print job can be printed by the printer, the program instructs the processor to transmit that print job from the print queue to the printer for printing. However, if that print job cannot be printed by the printer, then the program determines whether or not a second print job in the print queue can be printed by the printer. Preferably, if the second print job can be printed, the print-around program instructs the processor to transmit the second print job from the print queue for printing.

Flow chart 200 of FIGS. 4A, 4B and 4C is configured to transfer the identities of currently unprintable jobs from a Primary List to a Hold List, and then to later review the Hold List to determine whether any of the jobs identified therein can now be printed. The following description of the flow chart 200 will be described with reference to items identified in FIGS. 1 through 3.

With reference to FIG. 4A, the specific implementation shown begins at step 202, wherein the processor 150 (FIG. 2) checks a flag (a program feature indicating a particular state or condition) to determine whether a user has transmitted (or desires to transmit) a print job from a client device to the controller 130. If no job is sent (or is desired to be sent), then at step 204 the processor returns to again check the status of the “Job Sent” flag at step 202. However, if a print job has been sent to the central processor, then at step 206 the processor stores the print job received from the client device in the memory device 156, and also stores the identification of the new job in the next available location in the Primary Job List. At step 208 the processor checks to determine whether there is a print job identifier in the first position of the Hold List (190). If not, then at step 209 (FIG. 4B) the processor checks to determine whether there is a job identifier in the Primary List first location. If not, control returns to step 202 (FIG. 4A) to again check the “Job Sent” flag status. However, if there is a job identifier (ID) stored in the Primary Job List first location, then at step 210 (FIG. 4B) the processor transmits the attributes of the first job identified in the Primary List to the printer to determine whether the print job can be printed.

At step 212, if the processor determines that the point job can be printed, then the processor proceeds to execute step 214. At step 214 the print job identified in the first location of the Primary Job List is transmitted to the printer for printing. The job identifier is then deleted from the Primary Job List and the list of jobs identifiers is “advanced” to the next location such that the previously second identified job on the Primary Job List will now be the first identified job on the Primary Job List. The processor then returns to step 208 (FIG. 4A) to again determine whether there a print job identifier in the Hold List first location.

In this manner the program will print the first printable job identified in the Primary List if there are no other jobs in the Hold List, but, if there is a job in the Hold List, that job will be given priority consideration to determine whether it can now be printed (as will next be described). If there are no other jobs in the Hold List, the processor will check the Primary List to determine whether there are any remaining jobs pending. If not, the processor checks to determine if new jobs have been sent to the controller at step 202 (FIG. 4A).

If, at step 212 (FIG. 4B), the processor determines that the first job identified in the primary Job List cannot currently be printed by the printer, then at step 213 a printer error flag is set, and the program proceeds to step 218. At step 218 a job-hold time-out is initiated, and the user (or system administrator) is notified that a print job in the queue cannot be printed. The step of initiating the job-hold time-out can be performed by the electronic timer 153 of FIG. 2. As described above, the user can be notified via an alarm or alerted, via a display (e.g., 134, FIG. 1) or at the printer user interface 142 (FIG. 1). Then at step 220 (FIG. 4B) the processor checks to determine whether a predetermined period of time (for example, 2 minutes) has elapsed since the timer was initiated. If the predetermined period of time has not elapsed, then at step 222 the processor again checks to determine whether the printer effor flag is still set. Thus, the program provides a user the opportunity to address the condition that caused the error flag to be set. For example, if the printer control program notifies the user that the size A4 paper tray needs to be installed to print the job, and the user in fact inserts an A4 paper tray into the printer before the predetermined period of time has elapsed, then the error flag will be cleared and the processor will proceed to step 214 and print the job. However, if after the predetermined period of time has elapsed the error has not been addressed, then at step 224 the processor moves the job ID from the Primary List first location to the next available position on the Hold List, and advances the remaining jobs IDs (if any) on the Primary List to the next location in the list.

In one variation, additional program steps can be included which are executed when a user input signal is received by the processor. These steps can be initiated by a bypass switch (147, FIG. 1) on the printer user interface. The steps essentially instruct the controller to bypass steps 220 and 222 (FIG. 4B), thus causing the controller to bypass the time-out feature and proceed directly to place the job that cannot be printed on the Hold List. As will be explained in more detail below, once the job which cannot be printed is placed on the Hold List, other jobs in the queue which can be printed will then be printed. A user will be informed that the bypass switch can be accessed by the notification provided at step 218 (FIG. 4B).

At step 208 (FIG. 4A), if the processor has determined that there is a job in the first location on the Hold List, it will, at step 226, perform an attributes check, similar to step 210 (FIG. 4B), and will set an error flag if the job cannot be printed. From step 226 (FIG. 4A) control proceeds to step 228 (FIG. 4C), wherein the processor checks to determine whether an error flag is set which prevents printing of the first identified print job in the Hold List. If the first identified job can be printed, then at step230 the processor is instructed to transmit the first identified job in the Hold List to the printer for printing, and the first identified job ID is deleted from the Hold List. Then at step 234 the processor is instructed to determine whether there are any remaining jobs identified in the Hold List. If not, control is returned to step 209 (FIG. 4B) to determine whether there are any jobs identified in the Primary List. However, if at step234 (FIG. 4C) it is determined that there are remaining jobs identified in the Hold List, then at steps 238 and 240 the processor increments the identity of the jobs so that the next job identified in the hold list becomes the “first identified job in the Hold List.” These steps are also reached if, at step 228, the processor determines that the first identified job in the Hold List cannot currently be printed, and that there are additional jobs identities remaining in the Hold List (step 234). When there are remaining job Ids in the Hold List, the processor returns control to step 226 (FIG. 4A) to determine whether the currently identified job in the Hold List can be printed.

The steps of the print-around program in FIG. 4C essentially allow the processor to “scroll through” the list of job identities in the Hold List and determine whether any of them can currently be printed. Thus, the processor scrolls though the Hold List, searching for printable jobs, before it returns to the Primary List to determine whether there are any jobs identified therein. In this manner, jobs which are “on hold” are regularly reviewed and printed if possible, rather than the processor always giving priority to newly received jobs.

Preferably, the print-around program in the printer control program can be modified by a user (for example, a system administrator). For example, a user may desire to increase or decrease the duration of time before a job is placed on the Hold List. This can be performed by changing the value (T_{L}) in a memory location which is accessed by the program at step 220 (FIG. 4B) to determine whether the job identified in the Primary List has been unacceptably delayed for printing, and whether the processor should “print around” this job (i.e., whether the processor should take the next job in the queue and print it, if possible). Additionally, a user can disable the “print-around” feature by setting the condition at step 208 of FIG. 4A (“Job ID in Hold List first Position?”) to always default to “no”. The print-around feature can be enabled or disabled in this manner by a switch 147 (FIG. 1) mounted on the user console 142 of the imaging apparatus (printer) 140.

In another variation, the switch 147 (FIG. 1) on display 142 of printer 140 can be used to enable or disable the electronic timer (153, FIG. 2), as well as the program steps associated with the timer (steps 220 and 222, FIG. 4B). For example, if a first user has sent a first print job to the printer for printing, and the printer has determined that the first print job requires user intervention, then the controller holds the first print job in the queue. Subsequently, a second user transmits a second print job to the printer, and the second print job can be printed. However, due to the presence of the first print job, the second print job is not printed. A user sensible signal (such as a light or a text message) can be displayed at the user interface 142 of the printer 140 to indicate to users that print jobs are being held because at least one of the print jobs in the print queue requires user intervention. If the electronic timer feature is employed, then the bypass switch (147) can be used to bypass the timer, such that the next job in the queue which can be printed is immediately printed. In this manner a user (such as the second user in the above example) does not need to wait until the timer has exceeded the preset limit before the print-around feature can be accessed.

When an electronic timer feature is not employed, then the bypass switch 147 can be configured to allow the print-around feature to be manually engaged. For example, the printer system can be configured such that if there are two print jobs in the queue, and the first print job cannot be printed because it requires user intervention, then a latter, second print job in the queue will not be printed, even though it can currently be printed. However, when a user accesses the bypass switch 147, then an instruction is sent to the processor 150 instructing the processor to print the second job, and continue to hold the first print job in the queue.

The invention further includes a computer-readable storage medium for use in a computer system (e.g., central controller 130, FIG. 1) having a processor (150, FIG. 2) which is configured to execute computer executable instructions. The computer readable medium can be, for example, a diskette, a programmable module or microchip, a compact disk, a hard drive, or any other medium which can retain a computer readable program. The computer readable medium contains a set of instructions to control the transmission of print job data files from a memory device (e.g., 156, FIG. 2) to an electronic imaging device (e.g., printer 140, FIG. 1) for processing by the imaging device. The computer readable medium holds computer executable instructions to direct the processor to do the following: store a first print job in the memory device; store a second print job in the memory device; determine whether or not the first print job can be processed by the imaging device; and, when it is determined that the first print job cannot be processed by the imaging device, to determine whether or not the second print job can be processed by the imaging device. It will be apparent that these instructions can be specifically performed by executing the steps in the flowchart 200 of FIGS. 4A, 4B and 4C, and particularly at respective steps 206 (FIG. 4A) and 210 (FIG. 4B).

The computer readable medium can further include an instruction to transmit the second print job from the memory device (156) to the imaging device (140) for processing (e.g., printing), when the second print job can be processed by the imaging device and the first print job cannot be processed by the imaging device. Likewise, the medium can include instructions to begin measuring the passage of time (step 218, FIG. 4B), beginning with the completion of the instruction to determine whether or not the first print job can be processed by the imaging device when the first print job cannot be processed by the imaging device (step 210, FIG. 4B). Then the instruction can be to transmit the second print job from the memory device to the imaging device when the measured passage of time has exceeded a predetermined quantity (that is, to print the second job around the first job).

The computer readable medium can further include any or all of the features described and depicted in the flowchart 200. For example, it can include instructions to notify the user of the condition preventing printing of a job (step 218, FIG. 4B), as well as the feature of reviewing “on-hold” jobs to determine whether they are now printable (FIG. 4C).

The invention also includes a method for printing print jobs from a print queue with a printer. The method includes the steps of providing a readable memory device defining the print queue (e.g., hard drive 156 and queue 158), storing a first print job in a first location in the print queue (e.g., step 206, FIG. 4A and item 160 and 1621, FIG. 3), and storing a second print job in a second location in the print queue (e.g., item 163, FIG. 3). Then it is determined whether or not the first print job can be printed by the printer (e.g., step 210, FIG. 4B). When the first print job can be printed by the printer, then that print job is transmitted from the print queue to the printer (140, FIG. 1) for printing. However, when the first print job cannot be printed by the printer, then the method includes determining whether the second print job can be printed by the printer. When the second print job can be printed by the printer and the first print job cannot be printed by the printer, then the second print job is transmitted from the print queue to the printer for printing. In this manner, the second print job is “printed-around” the first print job to avoid unnecessarily delaying the printing of the second print job.

The method can further include transmitting the second print job to the printer only after a predetermined period of time has elapsed since it was determined that the first print job cannot be printed. This allows a user an opportunity to address the condition which caused the first print job to be unprintable, thus ensuring that print jobs requiring the attention of a user are not automatically relegated to second status.

The method can also include transmitting the second print job to the printer when the first job cannot be printed, but only after a user-provided instruction to do so has been provided. For example, the user-provided instruction can be provided by the bypass switch 147 (FIG. 1), as described earlier.

The method can also include the step of, after transmitting the second print job to the printer, repeating the steps of determining whether the first print job can be printed by the printer, and transmitting the first print job from the print queue to the printer for printing when the first print job can be printed by the printer. That is, the method includes those steps (228 through 240) of the flow chart depicted in FIG. 4C, wherein the program goes back to check whether a job which has been “printed-around” is now printable (e.g., a user has addressed the condition preventing printing), and printing the job if it can now be printed. This prevents print jobs which were previously “printed around” from being held in the print queue indefinitely.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method for printing print jobs from a print queue with a printer, comprising the steps of:
providing a readable memory device defining the print queue;
storing a first print job in a first location in the print queue;
storing a second print job in a second location in the print queue;
determining whether the first print job can be printed by the printer;
transmitting the first print job from the print queue to the printer for printing when the first print job can be printed by the printer; and
when the first print job can not be printed by the printer, determining whether the second print job can be printed by the printer.

2. The method of claim 1, and further comprising transmitting the second print job from the print queue to the printer for printing when the second print job can be printed by the printer and the first print job cannot be printed by the printer.

3. The method of claim 2, and further wherein the second print job is transmitted to the printer only after a predetermined period of time has elapsed since the step of determining whether the first print job can be printed was performed.

4. The method of claim 2, and further comprising, following the step of transmitting the second print job to the printer, repeating the steps of determining whether the first print job can be printed by the printer, and transmitting the first print job from the print queue to the printer for printing when the first print job can be printed by the printer.

5. The method of claim 2, and further comprising the steps of:
following the step of transmitting the second print job to the printer, deleting the second print job from the second location in the print queue;
storing a third print job in a third location in the print queue, wherein at least a portion of the third location corresponds to at least a portion of the second location; and
repeating the steps of determining whether the first print job can be printed by the printer, and transmitting the first print job from the print queue to the printer for printing when the first print job can be printed by the printer.

6. The method of claim 5, and further comprising determining whether the third print job can be printed by the printer when the first print job cannot be printed by the printer; and
transmitting the third print job from the print queue to the printer for printing when the third print job can be printed by the printer and the first print job cannot be printed by the printer.

7. The method of claim 2, and further comprising the steps of:
storing a third print job in a third location in the printer queue;
when the second print job cannot be printed by the printer, repeating the steps of determining whether the first print job can be printed by the printer, and transmitting the first print job from the print queue to the printer for printing when the first print job can be printed by the printer;
when the first print job cannot be printed by the printer, repeating the steps of determining whether the second print job can be printed by the printer, and transmitting the second print job from the print queue to the printer for printing when the second print job can be printed by the printer; and
when the second print job cannot be printed by the printer, determining whether the third print job can be printed by the printer, and transmitting the third print job from the print queue to the printer for printing when the third print job can be printed by the printer.

8. The method of claim 1, and further comprising the step of alerting a user when it is determined that the first print job cannot be printed by the printer.

9. A computer network comprising:
a central controller;
a computer readable memory device which can be accessed by the controller to thereby store electronic data to, and retrieve electronic data from, the memory device, the memory device defining a print job queue;
a plurality of client devices each capable of generating a print job comprised of a data stream of electronic signals, the client devices being in signal communication with the controller;
an imaging device in signal communication with the controller; and
a printer control program comprising a series of computer executable steps which can be executed by the controller to receive the print jobs from the client devices and store them in the print job queue, determine whether a first print job in the print job queue can be printed by the imaging device, transmit the first print job to the imaging device for printing when the imaging device can print the first print job, and determine whether a second print job in the print job queue can be printed by the imaging device when the first print job in the print job queue cannot be printed by the imaging device.

10. The apparatus of claim 9, and wherein the printer control program further comprises computer executable steps which can be executed by the controller to transmit the second print job to the imaging device for printing when the imaging device cannot print the first print job but can print the second print job.

11. The apparatus of claim 10, and further comprising an electronic clock in communication with the controller; and
wherein the printer control program further comprises computer executable steps which can be executed by the controller to start the electronic clock when the printer control program determines that the first print job in the print job queue cannot be printed by the imaging device, and transmit the second print job to the imaging device for printing when the electronic clock has measured a predetermined period of time.

12. The apparatus of claim 9, and further comprising and administration input console in signal communication with the central controller, and wherein the printer control program can be modified via the administration input console to disable the computer executable step of determining whether the second print job can be printed by the imaging device when the first print job cannot be printed by the imaging device.

13. The apparatus of claim 9, and wherein at least one of the client devices is in signal communication with the central controller via a radio frequency transmission.

14. The apparatus of claim 9, and wherein each print job is defined by print job attributes, and the imaging device comprises a printer controller configured to receive print job attributes from the central controller and to determine whether the imaging device is in a state to process a print job having given print job attributes, and to generate an error signal when the printer controller determines that the imaging device is not in a state to process a print job having given print job attributes.

15. The apparatus of claim 9, and wherein the imaging device further comprises a signal device to inform a user that a first print job in the print queue cannot be printer, the imaging device further comprising a bypass switch to allow a second print job in the print queue to be printed when the first print job cannot be printed and the second print job can be printed.

16. A computer-readable storage medium for use in a computer system having a processor configured to execute computer executable instructions to control the transmission of print job data files from a memory device to an electronic imaging device for processing by the imaging device, the medium holding computer executable instructions to:
store a first print job in the memory device;
store a second print job in the memory device;
determine whether or not the first print job can be processed by the imaging device; and
when it is determined that the first print job cannot be processed by the imaging device, to determine whether or not the second print job can be processed by the imaging device.

17. The computer-readable storage medium of claim 15 further holding computer executable instructions to transmit the second print job from the memory device to the imaging device for processing when the second print job can be processed by the imaging device and the first print job cannot be processed by the imaging device.

18. The computer-readable storage medium of claim 16 further holding computer executable instructions to, when the first print job cannot be processed by the imaging device, measure the passage of time beginning with the completion of the instruction to determine whether or not the first print job can be processed by the imaging device, and to execute the instruction to transmit the second print job from the memory device to the imaging device when the measured passage of time has exceeded a predetermined quantity.

19. The computer-readable storage medium of claim 16 further holding computer executable instructions to, following the instruction to transmit the second print job to the printer, repeat the instructions to determine whether or not the first print job can be processed by the imaging device, and to transmit the first print job from the memory device to the imaging device for processing when the first print job can be processed by the imaging device.

20. The computer-readable storage medium of claim 16 further holding computer executable instructions to generate an alarm when the first print job cannot be processed by the imaging device.

21. The computer-readable storage medium of claim 16 further holding computer executable instructions to generate a visible message comprising a description of a condition which has caused the first job to be unable to be processed by the imaging device.
